(19) United States
(12) Patent Application Publication
(10) Pub. No.: US 2007/0157804 A1
(43) Pub. Date: Jul. 12, 2007

(54) METHOD AND APPARATUS FOR DECOMMISSIONING AND RECYCLING RETIRED ADSORBENT-BASED FLUID STORAGE AND DISPENSING VESSELS

(76) Inventors: James V. McManus, Bethel, CT (US); Luping Wang, Brookfield, CT (US)

Correspondence Address: INTELLECTUAL PROPERTY / TECHNOLOGY LAW, PO BOX 14329, RESEARCH TRIANGLE PARK, NC, 27709, US

(21) Appl. No.: 11/619,935

(22) Filed: Jan. 4, 2007

Related U.S. Application Data
(60) Provisional application No. 60/756,956, filed on Jan. 6, 2006.

(51) Int. Cl. B01D 53/02

(52) U.S. Cl. 95/114

(57) ABSTRACT

A method and apparatus for decommissioning a fluid storage and dispensing system including a fluid storage and dispensing vessel containing adsorbent sorptively retaining residual fluid. The decommissioning involves removing the residual fluid, including superheating the adsorbent to temperature in a range of from (i) temperature substantially in excess of bulk desorption temperature of the fluid on the adsorbent, up to (ii) temperature substantially in excess of decomposition temperature of the fluid.

### BACKGROUND OF THE INVENTION

1. Field of the Invention

The present invention relates to method and apparatus for decommissioning and recycling adsorbent-based fluid storage and dispensing vessels, e.g., subsequent to their use in fluid storage and dispensing service.

2. Description of the Related Art

In the semiconductor manufacturing industry, high purity fluids are utilized extensively, and are supplied in a variety of packages.

Such fluid supply packages include conventional high pressure fluid cylinders, which have been ubiquitous in the industry since its inception. Although widely employed, such high pressure cylinders carry the associated risk of rupture and leakage, which in the case of many highly toxic and otherwise hazardous semiconductor manufacturing gases can entail catastrophic consequences.

As a result of the dangers attendant the use of high pressure hazardous fluids in the semiconductor manufacturing industry, a variety of enhanced safety fluid storage and dispensing systems have been developed. Among these are adsorbent-based fluid storage and dispensing systems commercially available from ATMI, Inc. (Danbury, Conn., USA) under the trademarks SDS, SAGE and VACsorb.

In these adsorbent-based fluid storage and dispensing systems, a physical adsorbent having sorptive affinity for the fluid of interest is contained in a vessel. The fluid is sorptively retained on the adsorbent, and desorbed under dispensing conditions. Such dispensing conditions may alternatively or additionally include heating of the adsorbent to effect thermally-mediated desorption, and/or imposition of a pressure gradient, e.g., a reduced dispensing pressure externally of the vessel, and/or imposition of a concentration gradient, e.g., by passage of a carrier gas through the mass of physical adsorbent with entrainment of the desorbed fluid.

In the aforementioned adsorbent-based fluid storage and dispensing systems commercially available under the trademarks SDS and SAGE, the fluid sorptively held on the physical adsorbent can be stored at subatmospheric pressure to provide a superior level of safety in the event of leakage or rupture, so that subsequent loss of fluid from the system is diffusional and highly limited, in contrast to bulk volumetric egress of fluid issued from a corresponding leaking or ruptured high pressure fluid cylinder.

In the aforementioned adsorbent-based fluid storage and dispensing systems commercially available under the trademark VACsorb, an enhanced level of safety is provided by a fluid pressure regulator interiorly disposed in a fluid storage and dispensing vessel holding a physical adsorbent having a sorptive affinity for the fluid of interest. The fluid in such system can be held at superatmospheric pressure, but the interior regulator prevents flow to the exterior of the vessel unless the exterior pressure is below the set point of the regulator. The regulator can for example have a subatmospheric pressure set point, so that loss of fluid from the vessel is diffusional and highly limited, as in the case of the aforementioned SDS and SAGE systems.

The above-discussed adsorbent-based fluid storage and dispensing systems in various circumstances require retirement, e.g., as a result of contamination, valve head damage, discontinuation of a specific fluid product, etc. Once retired, it is desirable to promptly decommission the system, so that useful components from the system, such as valves and valve parts, residual gas, adsorbent, fittings, port assemblies, etc. can be recycled, and hazards from the residual fluid contents of the system can be abated. Without appropriate decommissioning, inventories of the retired fluid storage and dispensing systems can proliferate and pose risks to the environment and/or the safety and operability of the facility in which the out-of-service fluid storage and dispensing systems reside.

When decommissioning adsorbent-based fluid storage and dispensing systems, it therefore is desirable to maximize the extent of recycling of the system parts and components, to correspondingly realize value and economic benefit from the retired system, minimize environmental issues, and increase user acceptance of such systems.

An effective decommissioning process is therefore needed for processing and disposition of retired adsorbent-based fluid storage and dispensing systems.

### SUMMARY OF THE INVENTION

The present invention relates to a method and apparatus for decommissioning adsorbent-based fluid storage and dispensing vessels, e.g., subsequent to their use in fluid storage and dispensing service.

The invention relates in one aspect to a method for decommissioning a fluid storage and dispensing system including a fluid storage and dispensing vessel containing adsorbent sorptively retaining residual fluid, such method comprising removing the residual fluid, including superheating the adsorbent to temperature in a range of from (i) temperature substantially in excess of bulk desorption temperature of the fluid on said adsorbent, up to (ii) temperature substantially in excess of decomposition temperature of the fluid.

In another aspect, the invention relates to an apparatus for decommissioning a fluid storage and dispensing system including a fluid storage and dispensing vessel containing adsorbent sorptively retaining residual fluid. The apparatus includes a heater adapted to superheat the adsorbent in the fluid storage and dispensing vessel to remove the residual fluid from the adsorbent, flow circuitry coupled to the fluid storage and dispensing vessel, a purge fluid source coupled to the flow circuitry, such flow circuitry containing flow control valves therein, with the flow control valves being selectively actuatable to flow purge fluid from the purge gas source through the flow circuitry into the fluid storage and dispensing vessel, a pump connected to the flow circuitry and adapted to extract the residual fluid from the fluid storage and dispensing vessel, and a scrubber connected to the flow circuitry and adapted to scrub fluid flowed thereto from the flow circuitry.

A further aspect of the invention relates to a method of manufacturing a microelectronic device, comprising use of a fluid produced by purification of a residual fluid removed from a fluid storage and dispensing system decommissioned by the decommissioning method of the invention.

Another aspect of the invention relates to a method of fabricating a fluid storage and dispensing system, comprising introducing to a fluid storage and dispensing vessel residual fluid removed from a fluid storage and dispensing system decommissioned by the decommissioning method of the invention, wherein the fluid storage and dispensing vessel contains adsorbent on which the residual fluid is adsorbed, and sealing the fluid storage and dispensing vessel for storage of the introduced fluid therein.

A still further aspect of the invention relates to a method of recycling a semiconductor manufacturing fluid, comprising decommissioning a fluid storage and dispensing system containing such semiconductor manufacturing fluid as residual fluid, according to the decommissioning method of the invention, and utilizing the residual fluid in a semiconductor manufacturing process.

Another aspect of the invention relates to a decommissioned fluid storage and dispensing apparatus, including a physical sorbent superheated to remove a residual fluid, with the physical sorbent having removed therefrom traces of a toxic gas.

In yet a further aspect, the invention relates to a decommissioned fluid storage and dispensing vessel containing a physical adsorbent having residual sorbate fluid thereon, in an impermeable encasement medium.

Other aspects, features and embodiments of the invention will be more fully apparent from the ensuing disclosure and appended claims.

### BRIEF DESCRIPTION OF THE DRAWINGS

FIG. 1 is a schematic representation of a decommissioning installation according to one embodiment of the invention.

FIG. 2 is a schematic representation of a decommissioning installation according to another embodiment of the invention.

FIG. 3 is a schematic representation of a decommissioning system according to another embodiment of the invention.

### DETAILED DESCRIPTION OF THE INVENTION, AND PREFERRED EMBODIMENTS THEREOF

The present invention relates to a method and apparatus for decommissioning adsorbent-based fluid storage and dispensing vessels, when same are retired from active fluid storage and dispensing service.

The disclosures of the following U.S. patents are hereby incorporated by reference herein, in their respective entireties: U.S. Pat. No. 5,518,528; U.S. Pat. No. 5,676,735; U.S. Pat. No. 5,704,965; U.S. Pat. No. 5,704,967; U.S. Pat. No. 5,707,424; U.S. Pat. No. 6,101,816; and U.S. Pat. No. 6,089,027.

The decommissioning method involves superheating of the fluid storage and dispensing vessel, at temperatures that facilitate the desorption and/or decomposition of the fluid from the adsorbent held in the vessel. For example, in order to decommission an arsine SDS® system, it is desirable to heat the fluid storage and dispensing vessel and associated valve head to temperature as high as 600° C. in order to remove all traces of arsine gas. The removal of all of the arsine gas from the system is necessary in order to be able to safely remove the cylinder valve and spent adsorbent after retiring the system.

In one embodiment, the decommissioning method involves utilizing temperatures that are high enough to effect decomposition of residual amounts of adsorbed gas.

Typically, when desorbing gas from an adsorbent, approximately 90-99% of the gas can be removed at temperatures below the decomposition temperature. The amount of remaining gas at this point is still too large to permit safe disassembly of the fluid storage and dispensing system. In order to remove the last remaining traces of gas, higher temperatures must be employed. For example, in the case of an arsine SDS® storage and dispensing system, temperatures >300° C. will initiate decomposition of the arsine gas to its constituent elements (H₂ and As) and higher temperatures will further increase the efficacy of the process.

In order to heat the fluid storage and dispensing system, a suitable heating source or medium can be employed, e.g., an external heat sources such as an electric or gas-fired furnace, steam, a liquid heat exchanger, an inductive heater, etc. Additionally, or alternatively, the interior of the fluid storage and dispensing vessel can be heated by injection of hot gas into the vessel. The heating medium, e.g., hot gas, can comprise an inert gas, or a reactive gas, as discussed more fully hereinafter.

In one implementation, the invention provides a method for decommissioning a fluid storage and dispensing system including a fluid storage and dispensing vessel containing adsorbent sorptively retaining residual fluid, in which the method involves removing the residual fluid, including superheating the adsorbent to temperature in a range of from (i) temperature substantially in excess of bulk desorption temperature of the fluid on the adsorbent, up to (ii) temperature substantially in excess of decomposition temperature of the fluid.

The residual fluid can be removed at any suitable temperature, e.g., a temperature of up to 600° C., or a temperature of up to 800° C., depending on the character of the adsorbent and the fluid sorptively retained thereon as residual fluid.

The decommissioning process may include recovery of the adsorbent from the vessel after removing the residual fluid therefrom, removal of the valve head or a valve component thereof from the fluid storage and dispensing system, and/or any additional steps by which the fluid storage and dispensing system or its component parts are remediated, recycled or otherwise disposed of.

The fluid in the fluid storage and dispensing system submitted to decommissioning can be of any suitable type, including, for example, a semiconductor manufacturing fluid, such as arsine, phosphine, diborane, boron trichloride, boron trichloride, silicon tetrafluoride, germanium tetrafluoride, phosphine, arsine, arsenic pentafluoride, phosphorus pentafluoride, hydrogen selenide, etc. The superheating to which the residual fluid is subjected may include elevated temperature levels chosen to effect decomposition of the residual fluid, e.g., into decomposition products that are readily removed from the adsorbent and associated vessel.

The decommissioning process may be carried out so that 90 to 99 percent by weight of the residual fluid is removed from the vessel at temperature below the decomposition temperature of the residual fluid.

The heating can be effected by any suitable exterior or interior (in relation to the vessel) heat source. In the case of an exterior heat source, a furnace or oven enclosure can be employed to hold the fluid storage and dispensing vessels, with each vessel in the enclosure being coupled in gas flow communication with flow circuitry including a manifold, and with the manifold being coupled in flow communication with a residual fluid recovery or destruction system. A pump may be coupled to the flow circuitry to pump residual fluid to such recovery or destruction system.

The decommissioning process in another embodiment includes subjecting the adsorbent and residual fluid thereon to multiple stages of heat ramping and/or heat soaking. These multiple stages may be conducted so as to control rate of desorption of the residual fluid from the adsorbent, to avoid thermal runaway reaction and to maximize amount of fluid that is desorbed in relation to the amount of fluid that is decomposed.

Alternatively, decomposition may be utilized as a primary modality for removing the residual fluid from the adsorbent in the fluid storage and dispensing vessel being decommissioned. For example, removing the residual fluid may involve initial heating to temperature in a range of from about 25° C. to about 200° C., followed by heating to higher temperature at which decomposition is a primary removing modality of the residual fluid. In one implementation of such method, a valve in the valve head of the fluid storage and dispensing apparatus is open during such initial heating, and closed at onset of decomposition of the residual fluid in the vessel.

Such onset of the decomposition of the residual fluid can be determined by monitoring the residual fluid, such as by a gas analyzer that is adapted to sense the presence of one or more decomposition products of the residual fluid, in fluid withdrawn or discharged from the fluid storage and dispensing vessel. The gas analyzer can be arranged to actuate the closure of the valve in the valve head upon sensing of a particular decomposition species.

The adsorbent that is present in the interior volume of the vessel being decommissioned can be of any suitable type, e.g., including a sorbent medium selected from among solid adsorbents, liquid adsorbents (such as an ionic liquid medium), and semi-solid adsorbents. In one preferred embodiment, the adsorbent includes a carbon material, such as a bead activated carbon material, or a monolithic carbon material. In another embodiment, the adsorbent includes molecular sieve material, such as crystalline aluminosilicate material.

The fluid storage and dispensing system that is amenable to decommissioning in accordance with the present invention, can be of any suitable kind, including for example, fluid storage and dispensing systems of a type as variously disclosed in U.S. Pat. No. 5,518,528; U.S. Pat. No. 5,704,965; U.S. Pat. No. 5,704,967; U.S. Pat. No. 5,707,424; U.S. Pat. No. 6,101,816; and U.S. Pat. No. 6,089,027. The fluid storage and dispensing system can for example include a vessel holding adsorbent retaining the residual fluid thereon, in which a pressure regulator is disposed in the interior volume of the vessel, and arranged to dispense fluid from the vessel at a pressure below the set point of the regulator.

In one specific embodiment, the fluid storage and dispensing system is heated in a furnace, with multiple fluid storage and dispensing systems in the hot zone of the furnace, and with the fluid storage and dispensing vessels of such systems being manifolded to a piping system that permits passage of desorbed gas and decomposition products to a recovery or destruction system. Such approach can be used for decommissioning a wide variety of fluid storage and dispensing systems, including those containing adsorbed gases such as boron trifluoride, silicon tetrafluoride, germanium tetrafluoride, phosphine, arsine, arsenic pentafluoride, phosphorus pentafluoride, hydrogen selenide, and the like.

In one preferred embodiment, the decommissioning method is conducted in stages involving temperature ramping and/or heat soaking, to control the rate at which gas is desorbed from the adsorbent. Such controlled character of the desorption process is desired as a safety precaution, in order to avoid thermal runaway reactions, and to maximize the amount of gas that is desorbed in relation to the amount of gas that is decomposed.

As an illustrative example, an arsine SDS® system undergoing initial stages of the heating in the decommissioning method, at temperatures in a range of from about 25° C. to about 200° C., will undergo almost exclusively thermal desorption, with very little decomposition of the adsorbate gas. As the temperature is increased further, thermal decomposition (of the gases that actually decompose) becomes the primary gas removal modality. In order to minimize the sublimation of solids (such as arsenic and arsenic pentaoxide in the case of an arsenic SDS® system) into the manifold extraction network, the SDS system valves can be closed when it is determined that decomposition has begun. Such determination of the onset of decomposition can be effected by use of a gas analyzer that is operatively disposed to detect the presence of a specific decomposition reaction product or products.

In another specific embodiment, an extraction manifold to which the fluid storage and dispensing systems are connected for removal of fluid, is coupled with a vacuum system to enhance the gas removal. Such vacuum system can be of any suitable type, including, without limitation, oil-based rotary pumps, mechanical dry pumps, diaphragm pumps, cold traps and cryogenic-type pumping systems. The cryogenic-type pumping system can be employed to trap desorbed gases, to enhance recovery of the extracted gas.

In a further embodiment, the decommissioning process and systems of the present invention can be utilized in combination with the method and apparatus described in U.S. Pat. No. 5,676,735 issued Oct. 14, 1997 in the name of James V. McManus for “Reclaiming System for Gas Recovery from Decommissioned Gas Storage and Dispensing Vessels and Recycle of Recovered Gas,” the disclosure of which hereby is incorporated herein by reference in its entirety.

Such combination may include the initial coupling of a used storage and dispensing vessel with at least one fresh vessel and employing different conditions, e.g., of temperature and/or pressure, in the respective vessels to effect transfer of a first portion of remaining fluid from the used vessel to the at least one fresh vessel, as described in U.S. Pat. No. 5,676,735, followed by further processing of the used vessel in accordance with the present invention, after the used vessel has been uncoupled from the fresh vessel(s).

Thus, the used vessel-to-fresh vessel transfer can be utilized to transfer from the used vessel any remaining free, e.g., interstitial gas, as well as sorbate fluid that is desorbed by the different conditions obtaining in the respective used and fresh vessels. For this purpose, the respective used and fresh vessels may be interconnected by a manifold or other flow circuitry. The used vessel then is removed from flow communication with the fresh vessel(s) and can be processed as disclosed herein for removal of residual fluid from the adsorbent in the used vessel.

The combination of the approach disclosed in U.S. Pat. No. 5,676,735 with the approach of the present invention is advantageous, allowing the method of U.S. Pat. No. 5,676,735 to be used for desorption of fluid from adsorbent in temperature regimes well outside the superheating thermal regimes used in the practice of the present invention.

In this respect, the high superheating temperatures employed in the practice of the present invention may cause the occurrence of thermally-mediated outgassing of extraneous gas species from the interior walls of the vessel and/or other high-heat reactions or interactions with system components that may introduce or generate contaminant species. Such extraneous contaminants are readily accommodated in the present inventive method and systems, e.g., by scrubbing, fractionation or other treatment techniques, but are inconsistent with the maintenance of high fluid purity in the vessel-to-vessel transfers of fluid that are contemplated by U.S. Pat. No. 5,676,735.

The vessel-to-vessel transfer of fluid from a used vessel to a fresh vessel, as described by U.S. Pat. No. 5,676,735, in combination with the decommissioning approach of the present invention, therefore can provide a highly effective fluid recycling and removal system and process, as a specific embodiment of the present invention.

Although described herein primarily in application to fluid storage and dispensing apparatus of a type in which a solid-phase physical adsorbent medium is employed for sorptively retaining gas for storage and subsequent dispensing of gas under desorption dispensing conditions, the utility of the invention is not thus limited. Contrariwise, the invention contemplates a wide variety of other types of fluid storage and dispensing apparatus, including fluid storage and dispensing apparatus in which other types of sorbent media are employed to store a fluid, for subsequent disengagement of the fluid from the sorbent medium under dispensing conditions.

In such respect, the sorbent medium may include a solvent, liquid, semi-solid, or other material having capability as a storage medium. For example, the fluid storage medium can be a reversible reactive liquid medium, e.g., an ionic liquid medium, capable of reactive uptake of fluid in a first step, and reactive release of previously taken up fluid in a second step, with the first and second steps being reverse reactions in relation to one another, and defining a reversible reaction scheme.

It would appear on first consideration that superheating of the adsorbent medium in the fluid storage and dispensing system, to temperature significantly above temperature applicable to bulk desorption, would involve uneconomic expenditures of energy and would be unproductive of high level removal of residual fluid (since the increased kinetic energy of fluid molecules during such heating would be likely to drive at least some adsorbate molecules deeper into smaller interior porosity of the porous adsorbent medium, making the last quantum of residuum extremely difficult to extract), in contrast to other desorption/removal methods such as sequential vacuum pumping and depressurization steps, in situ chemical reaction removal of the adsorbate from the adsorbent medium, etc. Despite such anticipated disadvantage, the superheating methodology of the invention has been determined to be highly advantageous in application to removal of adsorbed fluid species from adsorbent media to levels required for effective decommissioning of fluid storage and dispensing vessels subsequent to their retirement from active service.

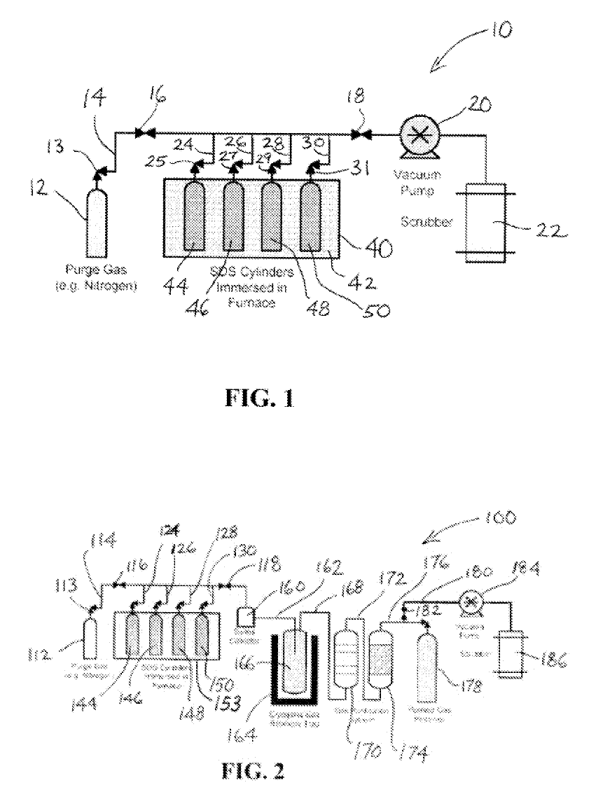

Referring now to the drawings, FIG. 1 is a schematic representation of a decommissioning installation 10 according to one embodiment of the invention.

The decommissioning installation 10 includes a source 12 of purge gas, such as nitrogen, helium or argon, or the like, in a containment vessel equipped with a valve head 13. The valve head 13 in turn is joined to extraction manifold 14 containing flow control valves 16 and 18, and vacuum pump 20, therein. At its end opposite the junction with valve head 13 of the purge gas source 12, the extraction manifold 14 is coupled with the scrubber 22.

The scrubber can be of any suitable type, including wet scrubber and/or dry scrubber units. In a preferred embodiment, the scrubber comprises a dry scrubber including a casing holding a bed of a chemisorbent medium that is reactive with extracted gas from the adsorbent-based fluid storage and dispensing vessels being decommissioned. The chemisorption reaction is carried out to irreversibly react the extracted gas with the scrubber medium and produce reaction products that for example can be solid-phase products with no appreciable vapor pressure, or that otherwise are benign or amenable to ready disposal.

The extraction manifold 14 as illustrated is joined by branch lines, 24, 26, 28 and 32 to the respective valve heads 25, 27, 29 and 31 of the fluid storage and dispensing vessels, 44, 46, 48 and 50, respectively. The fluid storage and dispensing vessels 44, 46, 48 and 50 are disposed in the interior volume 42 of the furnace 40, for heating thereof to drive off the residual fluid from the vessel (including fluid adsorbed on the physical adsorbent as well as fluid adsorbed on interior wall surfaces of the vessel, and residual fluid in the valve head of the vessel).

In the installation 10, the purge gas from purge gas source 12 can be flowed into the respective vessels in the furnace (with flow control valve 18 closed, and flow control valve 16 open), to thereby impose a concentration gradient between the purge gas and the adsorbed fluid of interest, effective for achieving desorption of residual adsorbate fluid from the physical adsorbent in the vessels, following which the purge gas flow can be terminated, by closure of flow control valve 16 and/or closure of a valve in the valve head 13 of the purge gas source 12.

Thereafter, valve 18 can be opened and vacuum pump 20 actuated, to extract fluid including the purge gas and desorbed/decomposed residual adsorbate fluid from the vessels in the furnace, for flow through the extraction manifold 14 to scrubber 22.

Such purge fill and vacuum pump extraction steps can be conducted in alternating fashion, for a number of repetitive cycles, as may be required to completely, or substantially completely, extract residual adsorbate fluid from the vessels in the furnace.

As another operating modality for the installation 10 of FIG. 1, the vessels 42, 46, 48 and 50 may be heated in furnace 40, with both flow control valves 16 and 18 in the extraction manifold 14 being closed, to achieve desorption of the residual adsorbate from the adsorbent in the respective vessels. After such thermal desorption has been effected to a desired extent, valves 16 and 18 can be progressively opened with actuation of vacuum pump 20, so that purge gas is flowed through extraction manifold 14 to the scrubber 22 for removal of the adsorbate from the purge gas stream. The resulting purge gas, depleted of adsorbate fluid, then can be discharged from the scrubber 22, and/or recirculated in the installation through the extraction manifold 14 (recycle line not shown in FIG. 1).

In still further alternatives, various permutations of purge gas filling, heating and vacuum extraction may be employed, as part of an overall process flow by which the residual adsorbate fluid is removed from the vessels disposed in furnace 40.

The installation shown in FIG. 1 allows the fluid storage and dispensing vessels to be heated in the oven to temperatures as high as 800° C., with the desorbed and/or decomposed gases treated by a gas destruction system, such as the above-described chemical dry scrubber.

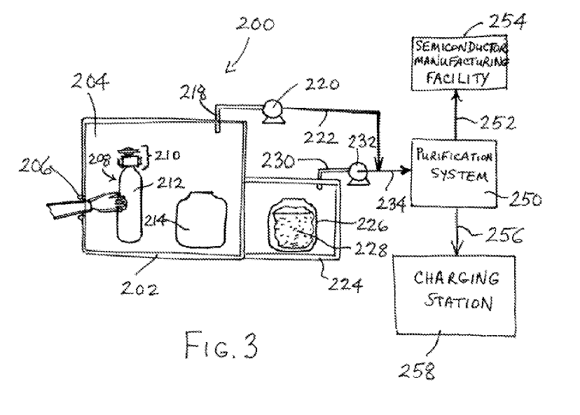

FIG. 2 is a schematic representation of a decommissioning installation 100 for removing the residual fluid from fluid storage and dispensing vessels 144, 146, 148 and 150 disposed in the furnace 153, according to another embodiment of the invention.

In this installation, a purge gas source 112, including a containment vessel equipped with a valve head 113, is joined in fluid supply relationship to extraction manifold 114. The extraction manifold 114 contains flow control valves 116 and 118 therein, and is coupled at its downstream end to a solids collector vessel 160. The respective fluid storage and dispensing vessels in furnace 153 are joined by branch lines 124, 126, 128 and 130 to the extraction manifold.

The solids collector vessel 160 can be of any suitable type, as effective to remove solids and particulate materials from the fluid flowed thereto from the extraction manifold 114. For example, the solids collector vessel 160 schematically illustrated in FIG. 2 can be constituted by a cyclone solids-fluid separator, or by a filter bag, or other suitable solids removal device or assembly. The solids collector vessel 160 is joined by fluid feed line 162 with the vessel 166 of the cryogenic gas recovery trap 164.

The recovery trap 164 may be cryogenically cooled by liquid nitrogen, liquid oxygen, or other cryogen, so as to freeze out the residual desorbate fluid from the fluid stream passed to the vessel 166 in feed line 162. The purge gas fluid is passed through the vessel 166 and flows in line 168 through the gas purification system including upstream purifier 170, transfer line 172, and downstream purifier 174 into discharge line 176. From line 176, the purge gas flows into effluent line 180, with the flow control valve 182 being open and the vacuum pump 184 being actuated to flow the purge gas into scrubber 186 and then out of the system (final discharge line not shown in FIG. 2).

After the residual adsorbate gas has been frozen out in the vessel 166, the purge gas flow can be terminated, and flow control valves 116 and 118 closed. The vessel 166 of the cryogenic gas recovery trap 164 thereupon is warmed, by terminating the flow or provision of cryogen, so that the frozen adsorbate fluid in the vessel 166 is thereby vaporized.

The resulting adsorbate vapor then is flowed in line 168 to the gas purification system including upstream purifier 170. In this initial purifier, the adsorbate from the cryogenic gas recovery trap is purified, then flowed in transfer line 172 to downstream purifier 174 for final purification and flow into discharge line 176. From line 176, the purified gas flows into purified gas receiver vessel 178, with the flow control valve 182 in effluent line 180 being closed and the vacuum pump 184 being deactuated. The purified adsorbate in this manner can be recovered in the purified gas receiver vessel 178, for reuse. This recovery scheme is particularly useful when the adsorbate is a costly reagent.

The purification media in purifiers 170 and 174 may be of any suitable type that is appropriate for removal from the adsorbate of impurity species that may be present in the adsorbate extracted from the vessels 144, 146, 148 and 150 as a result of superheating of the adsorbent in the vessels in the furnace 153.

The decommissioning system shown in FIG. 2 may be alternatively operated in various modalities, in similar fashion to the variant modes of operation of the FIG. 1 system, as described hereinabove.

In one embodiment of the decommissioning method of the invention, the adsorbent sorptively retaining residual fluid is removed from the fluid storage and dispensing vessel after removal of the valve head from the vessel. The vessel during such removal can be disposed in a containment enclosure, whereby the vessel is isolated from an ambient environment exterior to the containment enclosure during such removal. The containment enclosure can be constituted by a glove box or other suitable enclosure, and the adsorbent superheating can be conducted in a thermal desorption enclosure that is in or connected to the containment enclosure.

An adsorbent collection container can be disposed in the thermal desorption enclosure, and after removal of the valve head from the vessel, adsorbent is transferred from the fluid storage and dispensing vessel to the adsorbent collection container. The adsorbent collection container may be appropriately sized and constructed to accommodate the transfer of adsorbent from multiple fluid storage and dispensing vessels to the adsorbent collection container.

After the residual fluid is removed from the adsorbent, the adsorbent can be removed from the fluid storage and dispensing vessel. Such removal can be effected by establishing an open material removal port in the fluid storage and dispensing vessel to enable adsorbent to be removed therefrom. In one embodiment, the open material removal port is established by opening a preexisting openable material removal port. In another embodiment, the open material removal port is established by drilling or tapping an opening in the fluid storage and dispensing vessel.

The residual fluid can be of any suitable type, e.g., a fluid such as arsine or phosphine. The decommissioning system of the invention can be constructed and arranged in a wide variety of implementations. For example, the decommissioning system can include suitably flow circuitry coupled with other processing units or systems.

In one embodiment, the flow circuitry comprises a manifold that is coupled with a fluid purification system, such as a fluid purification system adapted to purify residual fluid to a purity for reuse, e.g., a purity of greater than 99.9 wt. % purity.

In another embodiment, the fluid purification system can include a distillation system, a trap-to-trap fractionation system, and/or an adsorption system.

In yet another embodiment, the fluid purification system includes an adsorption system featuring a water-sorptive medium, e.g., a zeolite adsorbent, for removing water from the residual fluid.

The fluid purification system in yet another variant comprises a series-connected array of cryogenically chilled vessels. The chilled vessels can be arranged so that each successive cryogenically chilled vessel in the array is maintained at a higher temperature than an immediately preceding cryogenically chilled vessel in the array. Impurities can thereby be removed from the residual fluid as the residual fluid flows from a vessel maintained at a lower temperature to a vessel maintained at higher temperature.

As another modification, the purification system can include a cryogenically chilled vessel coupled with a pump, whereby impurities of the residual fluid are pumped from the residual fluid while the residual fluid is in the cryogenically chilled vessel.

The fluid purification system can be coupled with a recycled fluid charging station, in which purified fluid produced by the fluid purification system is introduced to a fresh fluid storage and dispensing vessel containing adsorbent that is sorptive of the purified fluid.

The decommissioning system can include a reactive fluid supply that is arranged to introduce reactive fluid into the fluid storage and dispensing vessel after removing residual fluid from the vessel, so that only vestigial adsorbed fluid remaining on the adsorbent is present. The reactive fluid is selected to be reactive with the vestigial adsorbed fluid on the adsorbent for neutralization thereof. The reaction product preferably is a non-volatile reaction product to facilitate the decommissioning process.

In another embodiment of the invention, the decommissioning system can include a source of material that is introduced into the retired vessel to encase the sorbent and residual or vestigial sorbate fluid on such sorbent. For example, such encasement medium can be a vitreous material or other impermeable material that is introduced to the interior volume of the vessel, or the encasement medium may derive from a precursor or source material that is introduced to the interior volume and then processed therein to form the encasement medium in situ. The vessel then can be sealed with the bed or sorbent material immobilized in the encasement medium therein, and the vessel then can be subjected to final disposition.

The decommissioning system can further include a residual fluid purity monitor arranged to monitor purity of residual fluid, and to responsively actuate flow of the residual fluid to one of a purification system and a disposal system, depending on purity of the residual fluid as being within a first range amenable to purification in the purification system, or as being within a second range inconsistent with purification in the purification system and consistent with disposition by the disposal system.

Once purified, the recovered fluid from the decommissioned fluid storage and dispensing system can be recirculated or otherwise be reused, e.g., in manufacturing a microelectronic device, or otherwise in a semiconductor manufacturing process, or other application. Alternatively, the recovered fluid can be used to charge a fresh adsorbent-containing vessel, which after charging of the fluid is sealed. In one embodiment, the recovered fluid is arsine or phosphine, which after any necessary purification is employed for ion implantation.

The invention therefore contemplates in one embodiment a decommissioned fluid storage and dispensing apparatus, including a physical sorbent superheated to remove a residual fluid, with the physical sorbent having removed therefrom traces of a toxic gas.

FIG. 3 is a schematic representation of a decommissioning system 200 according to another embodiment of the invention. This system includes a containment enclosure 202 defining an enclosed interior volume 204, constituting a glove box by provision of a glove port 206 as shown. The enclosed interior volume 204 holds a fluid storage and dispensing apparatus 208 including a main cylinder body 212 containing adsorbent and a valve head 210 including a hand wheel, valve body, and associated ports and fittings.

The enclosed interior volume 204 of the containment enclosure 202 also contains a collection container 214 for collection of adsorbent from the fluid storage and dispensing vessel(s) disposed therein, since the enclosure 202 and the collection container may be sized to accommodate multiple fluid storage and dispensing vessels. The containment enclosure can be employed in such manner as a location for disassembly of the fluid storage and dispensing system, by removal of the valve head 210 from the associated cylinder 212, following which the adsorbent can be emptied into the collection container 214.

Thus, the fluid storage and dispensing system being decommissioned can be opened to the interior volume 204 so that free gas or other fluid from the cylinder is removed and exhausted from the interior volume through the conduit 218 having exhaust pump 220 coupled thereto. Once opened, the valve head can be removed from the cylinder and emptied of adsorbent, by pouring same from the cylinder into the container 214.

The containment enclosure may be coupled to a thermal desorption enclosure 224 enclosing an interior volume in which a collection container 226 is disposed, holding a quantity of adsorbent 228. The container 226 may be of a same type as container 214, and the thermal desorption enclosure may be a separate enclosure as shown in FIG. 3, or it may be disposed in the containment enclosure 202, as a constituent zone or part thereof. When the containment enclosure and thermal desorption enclosure are separate from one another, the enclosures may be provided with conveyor, belt or other transport structure, to transport the collection container of adsorbent from the containment enclosure to the thermal desorption enclosure.

The thermal desorption enclosure is provided with a heater or other thermal input structure, for heating of the adsorbent in the collection container, to remove residual fluid therefrom. The removed fluid then is exhausted from the thermal desorption enclosure by conduit 230 joined to exhaust pump 232, which is illustrated discharges to the discharge line 234, being augmented by the fluid pumped from the containment enclosure and flowed by pump 220 through line 222 into the discharge line 234.

From line 234, the removed fluid deriving from the fluid storage and dispensing apparatus enters the purification system 250, in which the fluid may be purified to a purity level suitable for reuse of the purified fluid. The purified fluid may for example be flowed in line 252 to the semiconductor manufacturing facility, 254, for use in manufacturing microelectronic device products or precursor structures therefore. Alternatively, the purified fluid may be flowed from the purification system 250 to the charging station 258, in which the purified fluid is charged to fresh adsorbent-containing cylinders which then are sealed after fluid charging and installation of valve heads, to enter service as fluid supply packages.

As a further alternative, the system shown in FIG. 3 may have a purity monitor (not shown) disposed in discharge line 234, and adapted to generate a signal indicative of the purity level of the recovered fluid. If the fluid purity is too low for purification, and more appropriate for waste, the signal may be used to actuate a flow valve that routes the recovered fluid to waste or final disposal. If the fluid purity is monitored as being appropriately high for reuse of the fluid after purification, then the signal from the purity monitor can be used to actuate flow of the recovered fluid to the purification system.

It will be appreciated that the apparatus and techniques used for recovering fluid from fluid storage and dispensing vessels may be widely varied within the broad scope of the present invention, and that decommissioning systems of the invention may be configured, implemented and operated in numerous alternative manners, consistent with the disclosure herein.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A method for decommissioning a fluid storage and dispensing system including a fluid storage and dispensing vessel containing adsorbent sorptively retaining residual fluid, said method comprising removing said residual fluid, including superheating said adsorbent to temperature in a range of from (i) temperature substantially in excess of bulk desorption temperature of said fluid on said adsorbent, up to (ii) temperature substantially in excess of decomposition temperature of said fluid.

2. The method of claim 1, characterized by at least one of the following characteristics:
(i) said residual fluid is removed at temperature of up to 600° C.;
(ii) said fluid storage and dispensing system includes a valve head and said decommissioning includes removal of the valve head or a valve component thereof from the system;
(iii) said decommissioning further includes recovery of the adsorbent from the vessel after removing said residual fluid therefrom;
(iv) said fluid comprises arsine;
(v) said superheating temperature includes temperature effective for decomposing residual fluid in said vessel;
(vi) from 90 to 99 percent by weight of said residual fluid is removed from the vessel at temperature below the decomposition temperature of the residual fluid, whereby said residual fluid can be purified and reused;
(vii) said fluid comprises arsine and said superheating temperature is effective to decompose arsine gas to hydrogen and arsenic;
(viii) the vessel is heated to said superheating temperature by an external heating source;
(ix) the vessel is heated to said superheating temperature by an external heating source, and said external heating source includes a heating source selected from the group consisting of electric furnaces, gas-fired furnaces, steam heating, liquid heat exchangers and inductive heaters;
(x) the vessel is heated to said superheating temperature by an internal heating source;
(xi) the vessel is heated to said superheating temperature by an internal heating source, and said internal heating source includes a heated gas injected into the vessel;
(xii) the vessel is heated to said superheating temperature in a furnace;
(xiii) the vessel is heated to said superheating temperature in a furnace, and at least one additional fluid storage and dispensing vessel containing adsorbent sorptively retaining residual fluid is present in said furnace and heated to superheated temperature therein;
(xiv) the vessel is heated to said superheating temperature in a furnace, and the vessel in said furnace is coupled in gas flow communication with flow circuitry including a manifold, and wherein said manifold is coupled in flow communication with a residual fluid recovery or destruction system;
(xv) the vessel is heated to said superheating temperature in a furnace, and the vessel in said furnace is coupled in gas flow communication with flow circuitry including a manifold, and wherein said manifold is coupled in flow communication with a residual fluid recovery or destruction system, and a pump is coupled to the flow circuitry to pump the residual fluid to the residual fluid recovery or destruction system;
(xvi) the residual fluid comprises fluid selected from the group consisting of arsine, boron trifluoride, silicon tetrafluoride, germanium tetrafluoride, phosphine, arsine, arsenic pentafluoride, phosphorus pentafluoride, and hydrogen selenide;
(xvii) removing said residual fluid comprises multiple stages of heat ramping and/or heat soaking;
(xviii) removing said residual fluid comprises multiple stages of heat ramping and/or heat soaking, wherein said multiple stages are conducted so as to control rate of desorption of the residual fluid from the adsorbent, to avoid thermal runaway reaction and to maximize amount of fluid that is desorbed to amount of fluid that is decomposed;
(xix) removing said residual fluid comprises initial heating to temperature in a range of from about 25° C. to about 200° C., followed by heating to higher temperature at which decomposition is a primary removing modality of said residual fluid;
(xx) removing said residual fluid comprises initial heating to temperature in a range of from about 25° C. to about 200° C., followed by heating to higher temperature at which decomposition is a primary removing modality of said residual fluid, wherein said fluid storage and dispensing system includes a valve head and a valve in said valve head is open during said initial heating, and closed at onset of decomposition of the residual fluid in the vessel;
(xxi) removing said residual fluid comprises initial heating to temperature in a range of from about 25° C. to about 200° C., followed by heating to higher temperature at which decomposition is a primary removing modality of said residual fluid, wherein said fluid storage and dispensing system includes a valve head and a valve in said valve head is open during said initial heating, and closed at onset of decomposition of the residual fluid in the vessel, further comprising monitoring the residual fluid removed from said fluid storage and dispensing vessel to determine said onset of decomposition, and thereupon responsively closing said valve in said valve head;
(xxii) said monitoring comprises use of a fluid analyzer adapted to sense at least one decomposition product of said residual fluid removed from said fluid storage and dispensing vessel;
(xxiii) said fluid storage and dispensing vessel is connected to a manifold adapted for said removing of said residual fluid;
(xxiv) said fluid storage and dispensing vessel is connected to a manifold adapted for said removing of said residual fluid, wherein said manifold contains flow control valves;
(xxv) said fluid storage and dispensing vessel is connected to a manifold adapted for said removing of said residual fluid, wherein said manifold contains flow control valves, wherein said manifold is coupled with a vacuum system adapted to remove residual fluid from said fluid storage and dispensing vessel during said removing;
(xxvi) said fluid storage and dispensing vessel is connected to a manifold adapted for said removing of said residual fluid, wherein said manifold contains flow control valves, wherein said manifold is coupled with a vacuum system adapted to remove residual fluid from said fluid storage and dispensing vessel during said removing, wherein said vacuum system comprises a vacuum extractor selected from the group consisting of oil-based rotary pumps, mechanical dry pumps, diaphragm pumps, cold traps and cryogenic pumps;
(xxvii) said adsorbent comprises a sorbent medium selected from the group consisting of solid adsorbents, liquid adsorbents, and semi-solid adsorbents;
(xxviii) said adsorbent comprises a carbon material;
(xxix) said adsorbent comprises an ionic liquid medium;
(xxx) said fluid storage and dispensing vessel is connected to a manifold adapted for said removing of said residual fluid, wherein said manifold contains flow control valves, wherein said manifold is coupled with a vacuum system adapted to remove residual fluid from said fluid storage and dispensing vessel during said removing, and said manifold is coupled with a source of purge fluid and said valves are selectively actuatable to flow purge fluid into said fluid storage and dispensing vessel;
(xxxi) said fluid storage and dispensing vessel is connected to a manifold adapted for said removing of said residual fluid, wherein said manifold is coupled with a scrubber selected from the group consisting of wet scrubbers and dry scrubbers; and
(xxxii) said fluid storage and dispensing vessel is connected to a manifold adapted for said removing of said residual fluid, wherein said manifold is coupled to at least one additional fluid storage and dispensing vessel containing adsorbent sorptively retaining residual fluid.

3. The method of claim 1, wherein said fluid storage and dispensing vessel is contained in a furnace adapted to heat said vessel during said superheating.

4. The method of claim 1, comprising introducing purge fluid into said fluid storage and dispensing vessel during said superheating.

5. The method of claim 4, wherein said purge fluid is extracted from said fluid storage and dispensing vessel by vacuum extraction during said superheating.

6. The method of claim 5, wherein repetitive purge fluid fill and extraction steps are conducted during said superheating.

7. The method of claim 1, wherein said fluid storage and dispensing vessel is maintained in a closed condition during a portion of said superheating, followed by opening of said vessel for said removing.

8. The method of claim 1, wherein said fluid storage and dispensing vessel is connected to a manifold adapted for said removing of said residual fluid, and the removed residual fluid is recirculated through the manifold.

10. The method of claim 1, further comprising processing the removed residual fluid by a process selected from among: scrubbing; treatment in a fluid destruction system; solids-removal treatment; cryogenic cooling to recover the removed residual fluid; purification of the removed residual fluid.

11. The method of claim 1, wherein fluid removed from said fluid storage and dispensing vessel includes residual fluid and purge fluid.

12. An apparatus for decommissioning a fluid storage and dispensing system including a fluid storage and dispensing vessel containing adsorbent sorptively retaining residual fluid, said apparatus comprising a heater adapted to superheat said adsorbent in said fluid storage and dispensing vessel to remove said residual fluid from the adsorbent, flow circuitry coupled to said fluid storage and dispensing vessel, a purge fluid source coupled to said flow circuitry, said flow circuitry containing flow control valves therein, said flow control valves being selectively actuatable to flow purge fluid from said purge fluid source through said flow circuitry into said fluid storage and dispensing vessel, a pump connected to said flow circuitry and adapted to extract said residual fluid from said fluid storage and dispensing vessel, and a scrubber connected to said flow circuitry and adapted to scrub fluid flowed thereto from the flow circuitry.

13. The apparatus of claim 12, characterized by at least one of the following characteristics:
(i) the heater comprises a furnace adapted to hold the fluid storage and dispensing vessel;
(ii) the heater comprises a furnace adapted to hold the fluid storage and dispensing vessel, and the furnace is adapted to hold at least one additional fluid storage and dispensing vessel containing adsorbent sorptively retaining residual fluid;
(iii) said flow circuitry comprises a manifold and branch lines interconnecting the manifold with each fluid storage and dispensing vessel in the furnace;
(iv) said flow circuitry is coupled with a solids collector adapted to remove solids from fluid removed from said fluid storage and dispensing vessel;
(v) said flow circuitry is coupled with a cryogenic fluid recovery trap adapted to recover the residual fluid;
(vi) said flow circuitry is coupled with a fluid purification system;
(vii) said flow circuitry is coupled with a residual fluid recovery container for collection of the residual fluid;
(viii) said flow circuitry is coupled with a fluid purification system, and the flow circuitry is coupled with a residual fluid recovery container for collection of residual fluid subsequent to purification thereof in the fluid purification system;
(viii) said flow circuitry is coupled with a solids collector, a cryogenic fluid recovery trap, a fluid purification system, and a purified fluid receiver container;
(ix) said heater is adapted to superheat said adsorbent to temperature in a range of from (i) temperature substantially in excess of bulk desorption temperature of said fluid on said adsorbent, up to (ii) temperature substantially in excess of decomposition temperature of said fluid;
(x) said residual fluid comprises arsine;
(xi) said heater is adapted to superheat said adsorbent to temperature effective for decomposing residual fluid in said vessel;
(xii) said residual fluid comprises arsine, and said heater is adapted to superheat said adsorbent to temperature effective to decompose arsine to hydrogen and arsenic;
(xiii) said heater comprises an external heating source selected from among electric furnaces, gas-fired furnaces, steam heating, liquid heat exchangers and inductive heaters;
(xiv) said heater comprises an internal heating source;
(xv) said heater comprises an internal heating source including a heated fluid injected into the vessel;
(xvi) the apparatus is adapted for processing of at least one additional fluid storage and dispensing vessel containing adsorbent sorptively retaining residual fluid;
(xvii) said heater comprises a furnace, and said fluid storage and dispensing vessel is contained in said furnace, and said flow circuitry is coupled in flow communication with a residual fluid recovery or destruction system;
(xviii) said residual fluid in said fluid storage and dispensing vessel comprises fluid selected from the group consisting of arsine, boron trifluoride, silicon tetrafluoride, germanium tetrafluoride, phosphine, arsine, arsenic pentafluoride, phosphorus pentafluoride, and hydrogen selenide;
(xix) said heater is adapted to conduct multiple stages of heat ramping and/or heat soaking;
(xx) said heater is adapted to conduct multiple stages of heat ramping and/or heat soaking, wherein said heater is adapted to control rate of desorption of the residual fluid from the adsorbent, to avoid thermal runaway reaction and to maximize amount of fluid that is desorbed to amount of fluid that is decomposed;
(xxi) said heater is adapted to initially heat said adsorbent to temperature in a range of from about 25° C. to about 200° C., followed by heating to higher temperature at which decomposition is a primary removing modality to remove said residual fluid from said adsorbent;
(xxii) said heater is adapted to initially heat said adsorbent to temperature in a range of from about 25° C. to about 200° C., followed by heating to higher temperature at which decomposition is a primary removing modality to remove said residual fluid from said adsorbent, and said fluid storage and dispensing system includes a valve head and a valve in said valve head that is openable during the initial heating, and closable at onset of decomposition of the residual fluid in the vessel;
(xxiii) said heater is adapted to initially heat said adsorbent to temperature in a range of from about 25° C. to about 200° C., followed by heating to higher temperature at which decomposition is a primary removing modality to remove said residual fluid from said adsorbent, and said fluid storage and dispensing system includes a valve head and a valve in said valve head that is openable during the initial heating, and closable at onset of decomposition of the residual fluid in the vessel, said apparatus further comprising a residual fluid monitor adapted to determine said onset of decomposition, and thereupon responsively actuate closure of said valve in said valve head;
(xxiv) said pump comprises a vacuum system adapted to remove residual fluid from said fluid storage and dispensing vessel, wherein said pump is selected from among oil-based rotary pumps, mechanical dry pumps, diaphragm pumps, cold traps and cryogenic pumps;
(xxv) said adsorbent comprises a sorbent medium selected from the group consisting of solid adsorbents, liquid adsorbents, and semi-solid adsorbents;
(xxvi) said adsorbent comprises a carbon material;
(xxvii) said adsorbent comprises an ionic liquid medium;
(xxviii) said scrubber is selected from among wet scrubbers and dry scrubbers;
(xxix) said flow circuitry is adapted for recirculation of at least a portion of the residual fluid after removal thereof from the fluid storage and dispensing vessel; and
(xxx) said fluid storage and dispensing vessel comprises an interior fluid pressure regulator.

14. The method of claim 1, wherein the adsorbent sorptively retaining residual fluid is removed from the fluid storage and dispensing vessel, wherein the vessel during such removal is in a containment zone, whereby the vessel is isolated from an ambient environment exterior to the containment zone during said removal.

15. The method of claim 14, characterized by at least one of the following:
(i) the containment zone comprises a glove box;
(ii) the adsorbent superheating is conducted in a thermal desorption zone that is in or connected to the containment zone; and
(iii) the adsorbent superheating is conducted in a thermal desorption zone that is in or connected to the containment zone, and an adsorbent collection container is disposed in the thermal desorption zone, and after removal of the valve head from the vessel, adsorbent is transferred from the fluid storage and dispensing vessel to the adsorbent collection container.

16. The method of claim 1, comprising removing adsorbent from said fluid storage and dispensing vessel.

17. The method of claim 16, comprising establishing an open material removal port in said fluid storage and dispensing vessel to enable adsorbent to be removed therefrom, wherein the open material removal port is established by opening a preexisting openable material removal port, or by drilling or tapping an opening in said fluid storage and dispensing vessel.

18. The method of claim 1, wherein said residual fluid comprises a fluid selected from among arsine and phosphine.

19. The method of claim 1, wherein the removed residual fluid is processed in a fluid purification system adapted to purify said removed residual fluid to a purity greater than 99.9 wt. %.

20. The method of claim 19, wherein purified fluid produced by said fluid purification system is introduced to a fresh fluid storage and dispensing vessel containing adsorbent that is sorptive of said purified fluid.

21. The method of claim 1, further comprising, after removing said residual fluid, introducing into the fluid storage and dispensing vessel a reactive fluid to react with vestigial adsorbed fluid remaining on said adsorbent for neutralization thereof.

22. The method of claim 21, wherein the reaction product of reaction of the reactive fluid and the vestigial adsorbed fluid is a non-volatile reaction product.

23. The apparatus of claim 12, further comprising a residual fluid purity monitor arranged to monitor purity of residual fluid, and to responsively actuate flow of the residual fluid to one of a purification system and a disposal system, depending on purity of the residual fluid as being within a first range amenable to purification in said purification system, or as being within a second range inconsistent with purification in said purification system and consistent with disposition by said disposal system.

24. A method of manufacturing a microelectronic device, comprising use of a fluid produced by purification of a residual fluid removed from a fluid storage and dispensing system decommissioned by the method of claim 1.

25. A method of fabricating a fluid storage and dispensing system, comprising introducing to a fluid storage and dispensing vessel residual fluid removed from a fluid storage and dispensing system decommissioned by the method of claim 1, wherein said fluid storage and dispensing vessel contains adsorbent on which said residual fluid is adsorbed, and sealing the fluid storage and dispensing vessel for storage of the introduced fluid therein.

26. A method of recycling a semiconductor manufacturing fluid, comprising decommissioning a fluid storage and dispensing system containing said semiconductor manufacturing fluid as residual fluid, according to the method of claim 1, and utilizing the residual fluid in a semiconductor manufacturing process.

27. The method of claim 26, wherein the semiconductor manufacturing fluid comprises one of arsine and phosphine, and the semiconductor manufacturing process comprises ion implantation.

28. The apparatus of claim 12, further comprising a supply of reactive fluid coupled to the flow circuitry and arranged to flow said reactive fluid into the fluid storage and dispensing vessel, after removal of said residual fluid therefrom, for reaction with vestigial adsorbed fluid remaining on said adsorbent for neutralization thereof.

29. A decommissioned fluid storage and dispensing apparatus, including a physical sorbent superheated to remove a residual fluid, with the physical sorbent having removed therefrom traces of a toxic gas.

30. A decommissioned fluid storage and dispensing vessel containing a physical adsorbent having residual sorbate fluid thereon, in an impermeable encasement medium.

31. The decommissioned fluid storage and dispensing vessel according to claim 30, wherein the impermeable encasement medium comprises a vitreous material.

32. The method of claim 1, wherein residual fluid is removed by introducing into the fluid storage and dispensing vessel a reactive fluid that reacts with the residual fluid.

33. The method of claim 32, wherein the reaction product of reaction of the reactive fluid and the residual fluid is a non-volatile reaction product.

34. The method of claim 1, wherein prior to removing said residual fluid, the fluid storage and dispensing vessel being decommissioned comprises a used fluid storage and dispensing vessel that contains more than said residual fluid, and said used vessel is coupled in flow communication with at least one fresh storage and dispensing vessel containing sorbent material therein having sorptive capacity for said fluid, with the fresh vessel being maintained at temperature and/or pressure conditions relative to the used vessel that cause fluid to be transferred from the used vessel to the fresh vessel, so that the used vessel subsequent to such transfer contains said residual fluid.
